(19) United States
(12) Patent Application Publication
(10) Pub. No.: US 2014/0096980 A1
(43) Pub. Date: Apr. 10, 2014

(54) Self-Extinguishing Sandwich Panel

(71) Applicant: Dariusz Dzegan, Michalowice (PL)

(72) Inventor: Dariusz Dzegan, Michalowice (PL)

(21) Appl. No.: 13/648,372

(22) Filed: Oct. 10, 2012

(51) Int. Cl. A62C 35/68

(52) U.S. Cl. CPC A62C 35/68
USPC 169/16

(57) ABSTRACT

The present invention relates to a fire extinguishing system that includes a self-extinguishing sandwich panel. The panel is provided with an insulation core, an outer skin layer, and flow pipes disposed within said core that have an inlet and an outlet. Sprinkler devices are secured to the outside of one side of the panel in holes executed in the outer skin layer of the panel. The sprinkler devices may be distributed spot-wise on the outside of the panel and may be connected to the flow pipes by splines that are situated outside of the panel in holes executed in the outer skin of the panel. The flow pipes receive a flow of water in the inlet from a water tank and, when the sprinklers become activated by detecting a fire, release the water through the sprinklers in order to suppress a fire.

### FIELD OF THE INVENTION

The present invention relates to a ceiling, roof, floor or wall sandwich panel that is equipped with a built-in fire extinguishing capability.

### BACKGROUND OF THE INVENTION

Currently known sandwich panels without sprinkler systems are used as wall or roof sheathing for homes, buildings, and larger scale buildings. In these sandwich panels, the insulation core is made of Styrofoam, polyurethane or rock wool. The core is placed in between two skin layers mostly made of steel plate or another durable material. The skin material is selected depending on the function of the erected building and conditions of the environment, including, in particular, the increased exposure to vibrations generated by production equipment, exposure to chemical conditions (for instance, enhanced exposure to erosion, temperature variations, variable outdoor temperature and low temperature inside the building, in the case of cooling buildings). Typically, galvanized-coated steel plate skins are used.

Unlike the present invention, there are no known self-extinguishing sandwich panels that may be used for heating or cooling a building surface or interior and/or exterior area during its daily operation. At the moment, the fire protection systems are separate equipment that are installed on the surface of ceilings and that are supplied with water in a situation of fire. A constant water or gas pressure is maintained in these systems. In the event of a fire, the elevated temperature shatters the glass bulb of the sprinklers to allow for the expulsion of the firefighting medium, typically water, onto the fire or other source of danger.

My U.S. Pat. No. 8,074,639, entitled “Building Panel” the disclosures of which are incorporated herein by reference, relates to a construction of sandwich panels that has a plurality of flow-pipes installed under the skin of the panel. In the '639 patent, the flow pipes may be placed on the first and/or second surface of the panel core in corrugations on the first and/or second core surface. The flow pipes are covered by an outer lining that corresponds to the corrugations in the first and/or second core surface of the panel. The plurality of flow pipes may receive a liquid medium and the flow pipe ends may be interconnected by, e.g., elbow attachments. The particular application of the '639 panels is for use in the construction of an exterior/interior wall or roof structure that provides various thermal effects, such as transmitting the heat energy absorbed by an exterior side of the panel to an interior side of the panel to aid in heating an area of a building or other structure on a cold day. However, the '639 panel does not contain a fire protection system, which is disclosed in the present invention.

The purpose of the present invention's self-extinguishing sandwich panels is to develop a system for extinguishing a fire that uses the sandwich panel to generate a water curtain to suppress the fire. In addition, the sandwich panel of the present invention also helps to secure the building structure during a fire by cooling down the surface of the panel via internal flow pipes installed within the core of the sandwich panel.

### OBJECTS OF THE INVENTION

It is an object of the invention to provide self-extinguishing sandwich panel that will generate a water curtain to suppress fire.

It is another object of the invention to secure a building structure by cooling down the surface of the building.

It is still another object of the invention to provide a self-extinguishing sandwich panel that provides high-level fire safety of large-sized buildings, production halls, retail areas, warehouses, etc.

It is yet another object of the invention to provide a wall, flooring, ceiling, or roofing system that performs a fire protection function.

It is a further object of the invention to provide a self-extinguishing sandwich panel system that helps to minimize loss caused by fire, minimize damage to the building, and to help save lives and preserve health.

### SUMMARY OF THE INVENTION

The present invention is directed towards a self-extinguishing sandwich panel for generating a water curtain to suppress fire and to secure a building structure by cooling down the surface of the building. The panel generally comprises, a core, an outer lining that lines the outside surface of the core, internal flow pipes that are disposed within the core, sprinkler devices that are attached at points along the internal flow pipes outside of the outer lining, an inlet valve at the inlet to the flow pipes for receiving a fluid, and an outlet valve at the outlet from the internal flow pipes to allow the fluid to leave the flow pipes. The internal flow pipes are connected preferably by splines with the sprinkler devices that are situated outside the panel in holes executed in the outer lining of panel. In addition, the sprinkler devices are distributed spotwise at points along the flow pipes as desired and are connected to the internal flow pipes preferably on one side of the panel. The sprinkler devices are arranged in such a way that they allow the sprinkling of a wide area in the event of a fire. When no fire is present, the fluid, preferably water that flows within the internal flow pipes, can cool down the panels to act, inter alia, as a fire preventative.

The self-extinguishing sandwich panels of the present invention are adapted to be connected to a fluid circulating system. For example, a fluid reservoir, such as a water tank, may be in communication with the inlet valve to the internal flow pipes to supply fluid to the flow pipes. The fluid reservoir may be in fluid communication with the inlet valve through at least one fluid supply pipe. Fluid may circulate through the internal flow pipes and leave through the outlet valve. At least one fluid return pipe may be in fluid communication with the outlet valve at one end on the return pipe. The return pipe may then be preferably connected to the fluid supply pipe at a different location on the fluid supply pipe than the water tank so that fluid from the return pipe bypasses the fluid reservoir and a closed system of fluid flow is created between the fluid supply pipe(s), the internal flow pipes, and the fluid return pipe(s). In another embodiment, the fluid return pipe may be connected to the fluid reservoir rather than the fluid supply pipe. At least one pump is also present to facilitate the circulation of the fluid throughout the system.

Should a temperature rise occur and/or should a fire be detected by the panel system and/or the fluid flow system, the sprinkler devices become activated and the fire extinguishing commenced. When the sprinkler devices become activated, the outlet valve on the internal flow pipes is preferably closed and the fluid flows through the sprinklers. In this event, the fluid reservoir continuously supplies fluid to the internal flow pipes to maintain fire extinguishing. The fluid reservoir is preferably of a certain size that has a fluid capacity that is suitable for supplying enough fluid to the internal flow pipes during fire extinguishing.

When the sprinklers are not activated there is a desired amount of fluid that may be set to flow through the system wherein the system may preferably be defined by, inter alia, the fluid reservoir, the fluid supply pipe(s), the internal flow pipes, and the fluid return pipe(s). Once the fluid level has been reached, the fluid reservoir preferably ceases supplying fluid to the system and the fluid preferably bypasses the fluid reservoir by having the fluid return pipe flow to the fluid supply pipe. Sensors are used to detect changes in various factors, such as but not limited to the fluid pressure in the system and/or the volume of fluid flowing throughout the system. Depending on these variables, a valve on the fluid reservoir may be opened or closed so that fluid is or is not supplied to the system.

When the sprinklers are activated and fluid is being depleted from the system via the sprinklers, the fluid reservoir is directed by the sensors to keep providing fluid to the flow pipes. The sensors preferably detect the change in the volume of the fluid flowing through the system and/or the water pressure in the system and preferably trigger the valve on the fluid reservoir to remain open to ensure that the volume of fluid flowing through the system is not less than a minimum level and/or that a minimum water pressure is reached.

The sensors are also preferably capable of detecting whether the sprinklers are activated. This may be achieved by a thermal sensor that determines if the temperature for activating the sprinklers has been reached and/or by a sensor that determines whether a valve on the sprinklers is open. When it is determined that the sprinklers are not activated, the fluid pressure and the volume of fluid flowing through the system is still preferably monitored to ensure that the pressure and/or volume of water does not fall below a minimum. In the case of either occurring, the sensors may transmit a signal to a control unit of the system that may then relay the information to an interface of the system that a leak in the system may be present because of the falling fluid pressure and/or volume of fluid in the system. In this situation, the control unit may preferably keep the flow valve on the fluid reservoir closed to prevent more fluid from entering the system and may preferably turn off the fluid pumps. This is in contrast to when the sensors determine that the sprinklers are activated. When the sprinklers are activated and the fluid pressure and/or volume of fluid in the system falls below a certain level, the control unit may preferably keep the reservoir's flow valve open and may even adjust the flow rate of the fluid by, for example, adjusting the speed of the fluid pumps.

In addition, there may also be a maximum fluid pressure level that is acceptable in the system. When the sensors detect a pressure that is higher than the acceptable level, they may transmit a signal to the control unit relaying this information. The control unit may then close the valves and turn off the fluid pumps to prevent any fluid from being circulated. In a situation like this, a clog may for example be present in the system and the control unit may convey this information to a user interface so that a user is alerted and can remedy the problem.

The sensors may also be equipped with a feature that allows the valves of the system to be automatically adjusted to adjust the rate of fluid flow in the system to maintain a level of fluid flow and/or fluid pressure in the system that is within an acceptable range. The present invention also allows, however, for the valves to be manually adjusted by, for example, inputting instructions into an interface that is connected to a control unit that receives information from the sensors or by manually opening or closing the valves. In addition, other ways to adjust the valves that are known in the art may also be used.

A fluid heater, such as a furnace, may also be included in the system and may contribute a heating function to the panels. The fluid in the system can be heated by the furnace and therefore have a thermal function to heat the enclosed area bound by the panel or panels. The heat from the fluid can be transmitted from the pipes to the colder adjacent area, such as the enclosure, in order to heat the enclosure.

The control unit, as referenced above, may be incorporated into the system in some embodiments and function as the brain of the system that processes the signals from the sensors and other components in the system and gives instructions accordingly and/or relays information to a user interface that is in communication with the control panel. The user interface allows a user to monitor the system and provide commands to the system, such as but not limited to adjusting the flow of one or more valves in the system, opening or closing one or more valves in the system, directing the furnace to heat the fluid to a desired temperature, etc.

The self-extinguishing sandwich panels are preferably used as ceiling or roof-type structures but may be used in floors or side walls. During the ordinary course of the day when a fire emergency is not present, a wall, flooring, ceiling, or roofing system made of the present invention's panels may also cool down or heat up the facility. A furnace or other fluid heater may be used to provide a heated fluid to the panels and/or a cooling means may be included to allow a user to cool the fluid to a desired temperature. In this embodiment, the sensors and valves may relay the temperature to the control unit of at least one area that is adjacent to one or more panels of the present invention. The control unit may then relay the information to the user interface. A user may input a command to cool or heat the area to a desired temperature. Based on the user's commands, the system may cool or heat the area until the desired temperature is reached. When the desired temperature is reached, the sensors may relay a command to the control unit to stop the supply of fluid to the system by closing one or more valves or by deactivating the pumps. Alternatively, the sensors may relay a command to maintain the supply of fluid to the system wherein the temperature of the supplied fluid is the temperature at which the room is desired to be regulated.

In the event of a fire, as stated above, the panels will generate a water curtain to suppress the fire. The use of a constantly circulating fire extinguishing agent, preferably water, allows for a quick response in the event of a fire. Other agents having fire suppressant or fire extinguishing capabilities may also be used other than water. In addition, the fluid, as stated above, also acts as a carrier for thermal energy. Even further, the system may be adjusted, if required and/or desired, to perform rapid cleaning of the air from dust generated during production, or to dilute gases that may be produced within the building, thus preventing a possible explosion.

The panel of the present invention may have a core that is made of Styrofoam, polyurethane, rock wool, or other materials used in making the core of a sandwich panel. The core is placed in between two skin layers mostly made of steel plate or another durable material. For example, galvanized coated steel plate skin layers may also be used. However, as noted previously herein, other skin materials may be used that may be selected depending on the function of the erected building and conditions of the environment.

### BRIEF DESCRIPTION OF THE DRAWINGS

FIG. 1 shows a transparent elevational view of an embodiment of the self-extinguishing sandwich panels of the present invention.

FIG. 2 is a transparent longitudinal cross-sectional view of the self-extinguishing sandwich panel of FIG. 1.

FIG. 3 is a transparent vertical cross-sectional view of an alternate embodiment of the arrangement of flow pipes in the core of the self-extinguishing sandwich panel.

FIG. 4 shows an alternate embodiment of the arrangement of flow pipes shown in FIG. 2.

FIG. 5 shows an embodiment where retaining members secure the flow pipes of FIG. 4 inside of the panel.

FIG. 6 is an illustration of an embodiment of the fluid flow system of the present invention that shows the components of the system, including a plurality of self-extinguishing sandwich panels, interconnected.

FIG. 7A is a close up view of a sprinkler device that is connected at a point along the flow pipes.

FIG. 7B is a view taken along sectional line A-A of FIG. 7A.

FIG. 8 shows an embodiment of the self extinguishing sandwich panels used as roof panels. The view is a sliced view of the sandwich panels.

FIG. 9 shows an alternate embodiment of the self extinguishing sandwich panels used as roof panels. The view is also a sliced view of the sandwich panels.

FIG. 10 shows an embodiment of the self-extinguishing sandwich panels of FIG. 8 wherein the self-extinguishing sandwich panels are also used as the wall panels. This view is also a sliced view.

FIG. 11 shows an embodiment of the self-extinguishing sandwich panels of FIG. 9 wherein the self-extinguishing sandwich panels are also used as the wall panels. The view shown here is also a sliced view.

### DETAILED DESCRIPTION OF THE INVENTION

The present invention relates to a modular self-extinguishing sandwich panel that comprises a core having at least a first side surface and a second side surface and at least a first end and a second end. The panel also comprises an outer lining that lines at least a portion of the first side and second side surface of the core. In addition, the self-extinguishing sandwich panel also contains a fire extinguishing means to generate a water curtain to suppress a fire. The modular sandwich panel can be connected to one or more other modular panels to provide broader surface coverage for its fire extinguishing properties. The fire extinguishing means defines a system of a fluid flow of a fire suppressant, preferably liquid water, to respond in the case of a fire. The fire extinguishing means comprises at least one flow pipe disposed inside of the panel adjacent to or inside of the panel's core. At least one sprinkler device may be connected to the flow pipe(s) on the outside of the panel's outer lining and the connection may be through a stub portion of the flow pipe(s) that extends through a hole in the outer lining. In other embodiments however, the sprinkler device may have a neck portion that extends through a hole in the sandwich panel's outer lining and connects to a point along the flow pipes wherein the point on the flow pipes may be a port receives the sprinkler's neck portion. It is to be noted other known ways for connecting a sprinkler device to a piping may also be used in the present invention's self-extinguishing sandwich panel.

A reservoir or other fluid source may also be utilized in the present invention to supply fluid to the flow pipes. The reservoir may supply fluid via at least one fluid supply pipe to an inlet of the flow pipes wherein the inlet may contain a flow valve. An outlet valve may be positioned at an outlet of the system and it may preferably be at a different point along the flow pipe(s) than the inlet. The outlet valve allows the fluid to leave the set of flow pipes. Preferably, the outlet valve allows the fluid to flow to at least one fluid return pipe. The fluid return pipe preferably connects to an end of the fluid supply pipe to form a closed system of fluid flow through the set of flow-pipes.

A fluid reservoir, e.g., a water tank, piping to a fluid fire suppressant source or water source may be in fluid communication with fluid supply pipe but preferably may not be in communication with the fluid return pipe. In this way, when a fire emergency is not present, the fluid in the system may pass from the fluid supply pipe to the inlet valve, through the set of internal flow pipes to the outlet valve, and then from the outlet valve to the fluid return pipe. The fluid return pipe may preferably be in communication with the fluid supply pipe so that the fluid flows from the fluid return pipe to the fluid supply pipe.

In the event of a temperature rise, which is generally indicative of a fire, the sprinkler devices become activated via sensors and a valve on the sprinklers becomes open to allow fluid from the system to be expelled through the sprinkler devices to generate a water curtain that suppresses the fire. When this occurs, the outlet valve may preferably be closed so that all of the fluid is directed out of the sprinkler devices and the valve on the fluid reservoir may be open to allow fluid to be continuously pumped through the system via at least one pump. The pump may be controlled by a control unit of the system and it may be instructed by the control unit to turn on/off or adjust the rate of fluid flow. The command by the control unit to the pump may be based on a variety of information, such as but not limited to the information received from the sensors regarding the fluid pressure, the volume of fluid flowing through the system, etc.

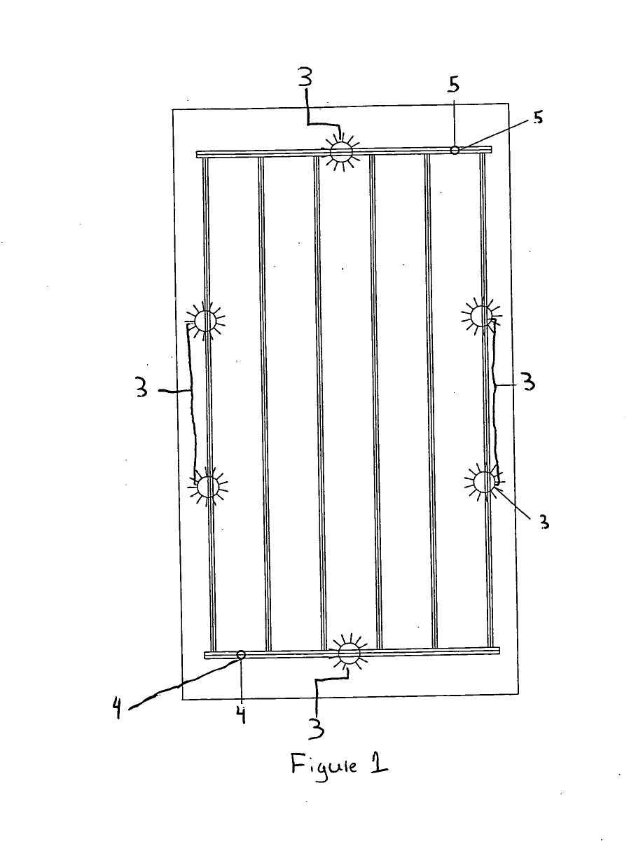

An embodiment of the subject of the invention is shown in the attached drawings, in which FIG. 1 shows an elevational view of the self-extinguishing sandwich panel 1 with the flow-pipes 2 and sprinkler devices 3. Also seen is the inlet valve 4 positioned at the inlet to the flow pipes and the outlet valve 5 positioned at the outlet from the flow pipes. As is seen from FIG. 1, the flow pipes 2 in this embodiment are a plurality of pipes arranged in the sandwich panel 1 but in other embodiments there may be only one single pipe in the panel. In addition, joints other than those shown in FIG. 1 maybe used. For example, elbow or other known joints may be used rather than right angle joints. There may also be in other embodiments more or less sprinkler devices 3 than are shown in FIG. 1.

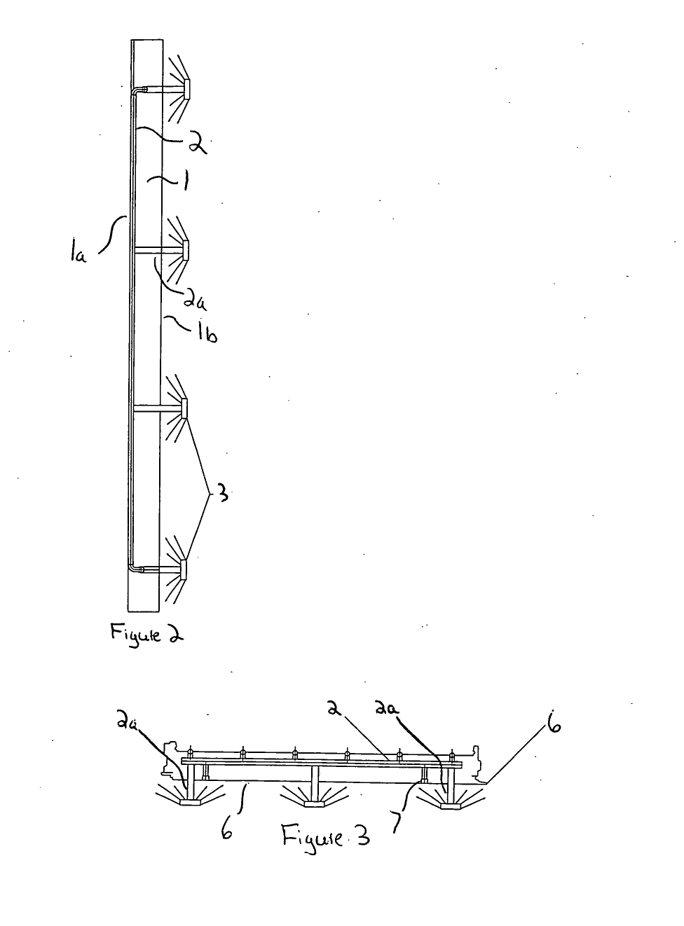

FIG. 2 shows a longitudinal cross-sectional view of the self-extinguishing sandwich panel 1 with the flow pipes 2 and sprinkler devices 3. In the embodiment shown in FIG. 2, the flow pipes 2 are positioned at a first side surface 1a of the sandwich panel core and have stubs 2a that extend to the second side surface 1b where the stubs protrude from the outer lining 6 of the second side surface 1b and connect to the respective sprinkler device 3.

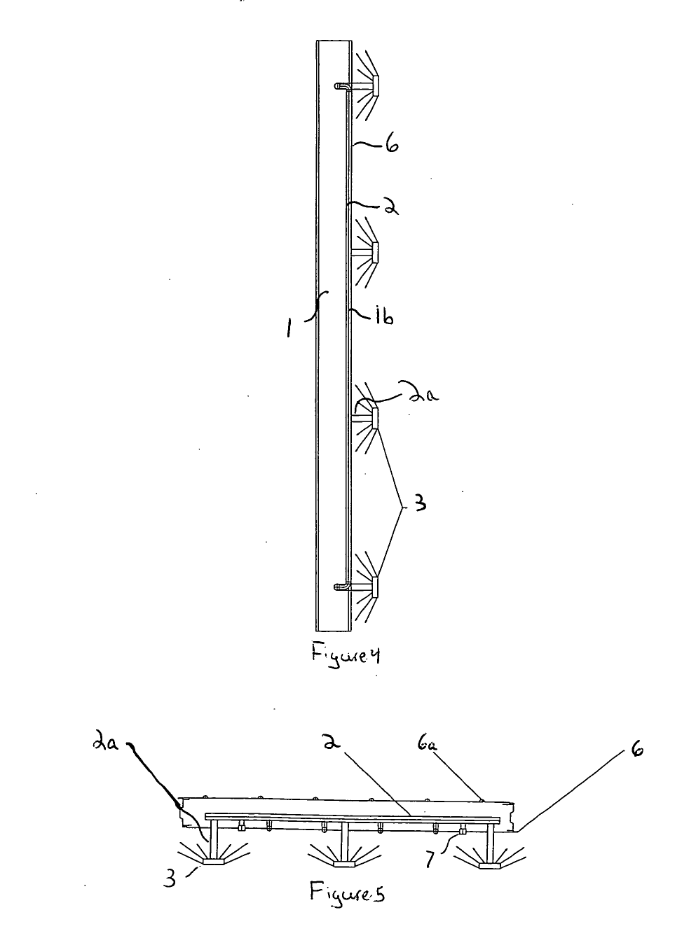

FIG. 3 shows a vertical cross section of a further embodiment of the sandwich panel. Shown in this embodiment is the connection between the flow pipes 2 and the pipes 7 supplying fluid to and receiving water from the flow pipes 2. The pipes supply water to the flow pipes 2 preferably at an inlet to the flow pipes. Similarly, the pipes receive water from the flow pipes 2 preferably at an outlet from the flow pipes. These connection points are what enables the flow pipe to establish a flow of water and/or other fire suppressant throughout the system.

Illustrated in FIG. 4 is an alternate embodiment of the arrangement of the flow-pipes shown in FIG. 2. Here, the flow pipes 2 are secured underneath the outer lining 6 of the panel at the same side surface of the core that the flow pipe stubs extend from. The embodiment shown in FIG. 2, by contrast, had the flow pipes secured at the side surface of the core that was opposite the side the stubs extended from. In particular, the flow pipes in FIG. 4 are secured underneath the second side surface 1b of the core. The stubs 2a project out of the outer lining on the second side surface 1b where they connect to a respective sprinkler device 3.

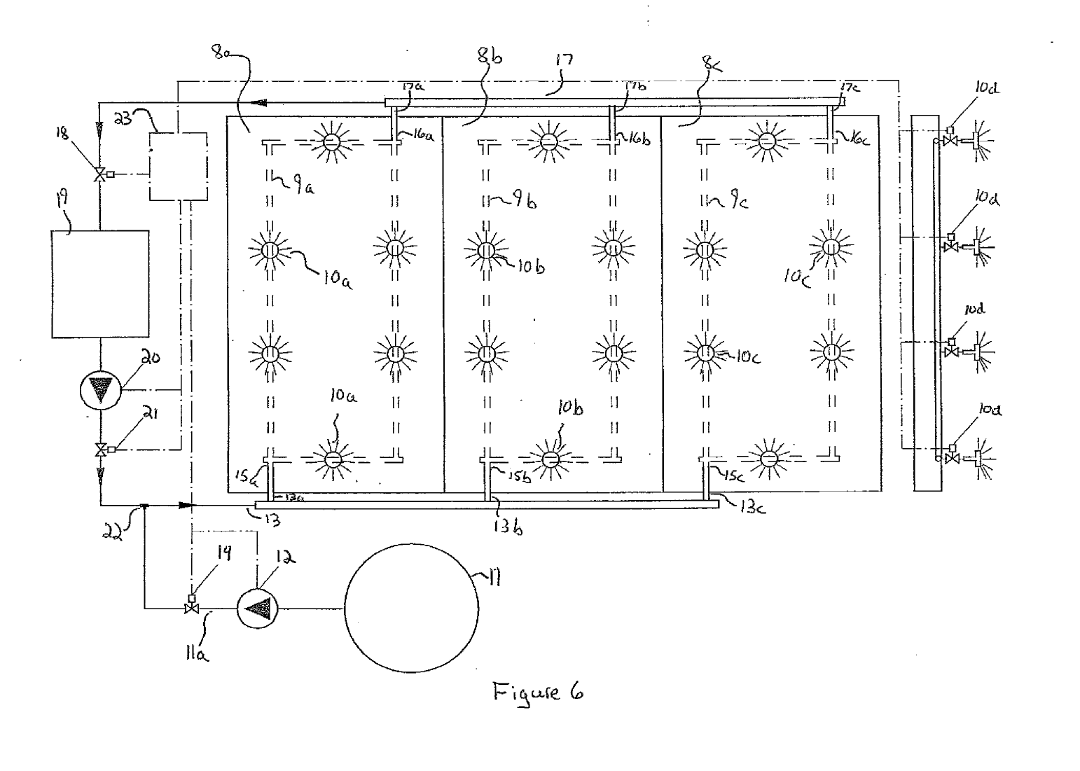

FIG. 5 shows a representation of the FIG. 4 arrangement of the flow pipes wherein the pipes 7 supplying water to and receiving water from the flow pipes 2 are seen being connected at points along the flow pipes 2. The pipes 7 preferably receive water from the flow pipes at an outlet from the flow pipes and supply water to the flow pipes at an inlet to the flow pipes. The outlet and inlet preferably have an outlet valve and an inlet valve, respectively. There may also be corrugations 6a in the outer lining of the sandwich panel. The corrugations 6a contribute to the structural integrity of the panel and allow for the mounting of the pipes inside of the panels. Alternatively, other features known in the art for providing structural integrity may be used in addition to or rather than corrugations.

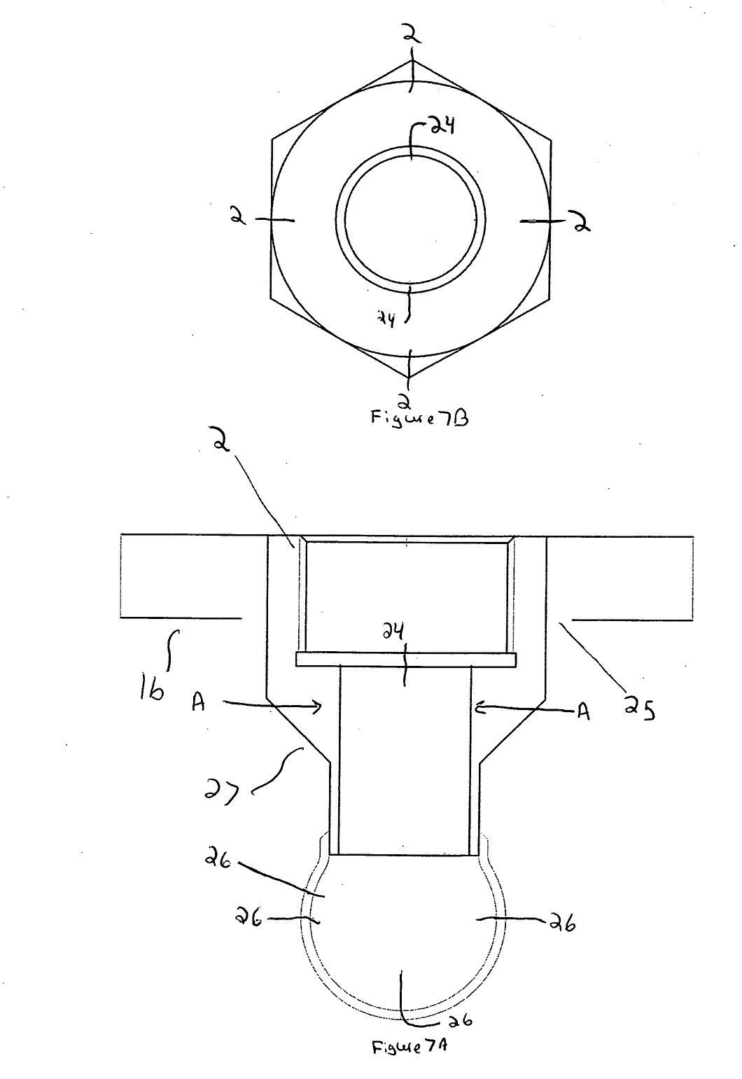

FIG. 6 shows an embodiment of a fluid flow system that may be used with the sandwich panels of the present invention. FIG. 6 includes a plurality of self-extinguishing sandwich panels that are interconnected. Seen is a transparent view of a first sandwich panel 8a, a second sandwich panel 8b, and a third sandwich panel 8c in series. A plurality of flow pipes 9a, 9b, and 9c are installed in the panels and sprinkler devices 10a, 10b, and 10c are disposed at points along the flow pipes, respectively. A tank 11 provides fluid to each panel 8a, 8b, and 8c through a tank supply pipe 11a that is connected at a point to the fluid supply pipe. Along the tank supply pipe 11a is a tank fluid pump 12 that facilitates the transmission of the fluid from the tank supply pipe 11a to the fluid supply pipe 13. A valve 14 is also present on the tank supply pipe 11a downstream of the tank fluid pump 12. Once the fluid reaches the fluid supply pipe 13, the fluid supply pipe delivers the fluid to each panel 8a, 8b, and 8c by having sections 13a, 13b, and 13c that branch off into the inlet 15a, 15b, and 15c of the flow pipes of each panel. The fluid flows through the flow pipes of each panel and through the sprinkler devices if activated. When the sprinkler devices are not activated, the fluid flows through the flow pipes to the outlet 16a, 16b, and 16c of each respective panel. The fluid flows out of the outlet and to the fluid return pipe 17 by first flowing through branched sections 17a, 17b, and 17c of the fluid return pipe 17.

The system in FIG. 6 then shows the fluid return pipe 17 directing the fluid away from the panels, through a valve 18, through a furnace 19, through a second fluid pump 20, and through a second valve 21. After flowing through the second valve 21, the fluid then flows to a junction 22 which joins an end of the fluid return pipe 17 with an end of the fluid supply pipe 13. The tank supply pipe 11a also branches off of the junction 22.

The junction 22 joining the tank supply pipe 11a, the fluid supply pipe 13, and the fluid return pipe 17 may have a means for allowing only the flow of the fluid return pipe and blocking off the flow of the tank supply pipe or vice versa. Furthermore, the junction may allow for the flow of fluid to the fluid supply pipe 13 from both the fluid return pipe 17 and tank supply pipe 11a.

Further seen in FIG. 6 is a side profile view of one section of the flow pipes and sprinklers. Seen in this view are the valves 10d that are connected to the sprinkler devices to regulate flow through the sprinklers. There are also preferably sensors (not shown) incorporated into the valves to detect a fire emergency via a rising temperature. The sensors may transmit to the control unit 23 when temperature rises above a certain threshold at the sprinkler devices. When this occurs, the control panel may open the valves at the sprinkler devices and allow water to be sprayed outside of the sprinklers. It is important to note that only certain sprinkler devices may be activated in an embodiment while others may remain deactivated depending on the respective sensors for the respective sprinkler device. In other embodiments, however, all the sprinklers may be automatically activated when one sprinkler is activated.

The control unit 23 may be connected to the pumps, and valves of the system to regulate the flow of fluid throughout the system. In an alternate embodiment, the control unit may also be connected to the furnace, a valve (not shown) on the tank, and/or other components of the system. Also included in the system but not shown in FIG. 6 may be at least one sensor located at any point in the system that is in electric communication with the control panel to transmit various data. The sensor can preferably detect and transmit data relating to the fluid pressure in the system, the volume of fluid flowing through the system, the flow rate of the fluid through the system, the temperature of the fluid, whether the sprinklers have been activated, etc. Additionally, sensors may be incorporated into the valves of the system to relay additional information.

The foregoing figures show the flow pipes as traveling in a horizontal configuration throughout the sandwich panels' core. However, in alternate embodiments, the flow pipes may travel in an alternating up and down vertical alignment or a combination of a vertical and horizontal alignment. Additionally, the pipes are preferably comprised of a non-rust material that is durable, such as but not limited to a non-rust metal or PVC piping. The valves are also preferably solenoid valves but other known valves may be used.

It will be appreciated by those skilled in the art that two or more panels may be connected to form a roof, ceiling, floor, and/or wall type structure. The panels may be in fluid communication to the system by the way that was depicted in FIG. 6 or other alternatives are possible. For example, an alternate embodiment allows for the panels to have protrusions on one or more of their edges that are designed to mate with couplings on the edges of a different panel. The protrusions are in fluid communication with the panel from which they extend so that fluid from the first panel may be transmitted to the second panel. It will also be appreciated by those skilled in the art that one or more of the components in FIG. 6 may be deleted or rearranged or more components may be added to the system, such as but not limited to more valves, more pumps, one or more reservoirs, etc.

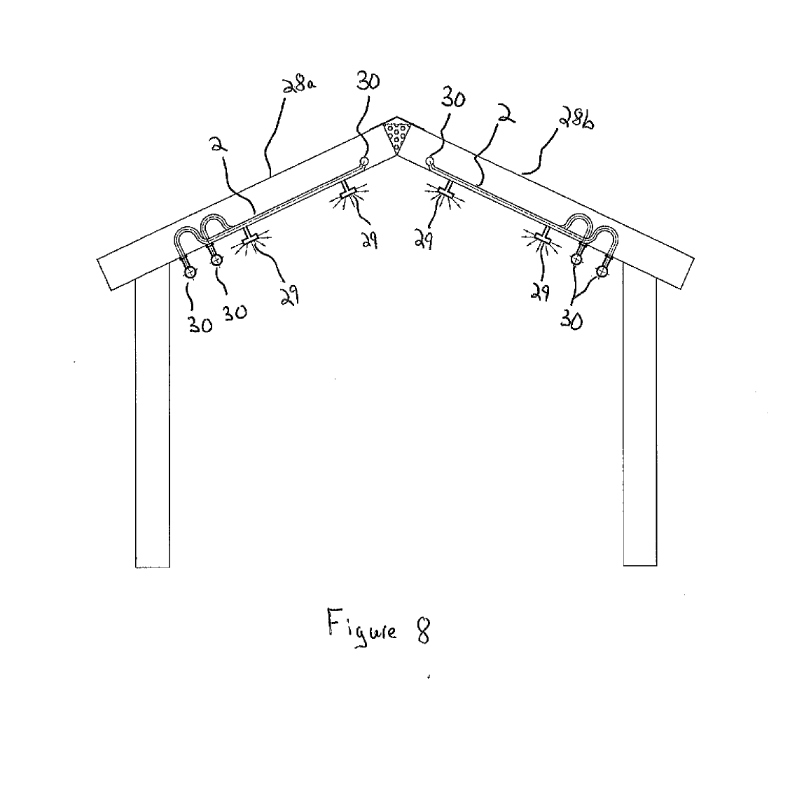

FIG. 7A provides a close up view of an embodiment of a connection of the sprinkler device to a point along the flow pipes. The flow pipes 2 are shown in this embodiment as having a stub 24 extending therefrom and through a hole 25 in the outer lining of the second side surface 1b of the panel core. A sprinkler device 26 is attached to the end of the stub that is situated outside of the sandwich panel. The sprinkler device in FIG. 7A is an alternate structure of the sprinkler device that has been shown in the previous Figures. Further shown in FIG. 7A is an embodiment of the present invention wherein a sheath 27 may cover the flow pipes and extending stubs. The sheath may serve as an additional layer of protection for the flow pipes and extending stubs. FIG. 7B shows a cross sectional view of the line A-A in FIG. 7A.

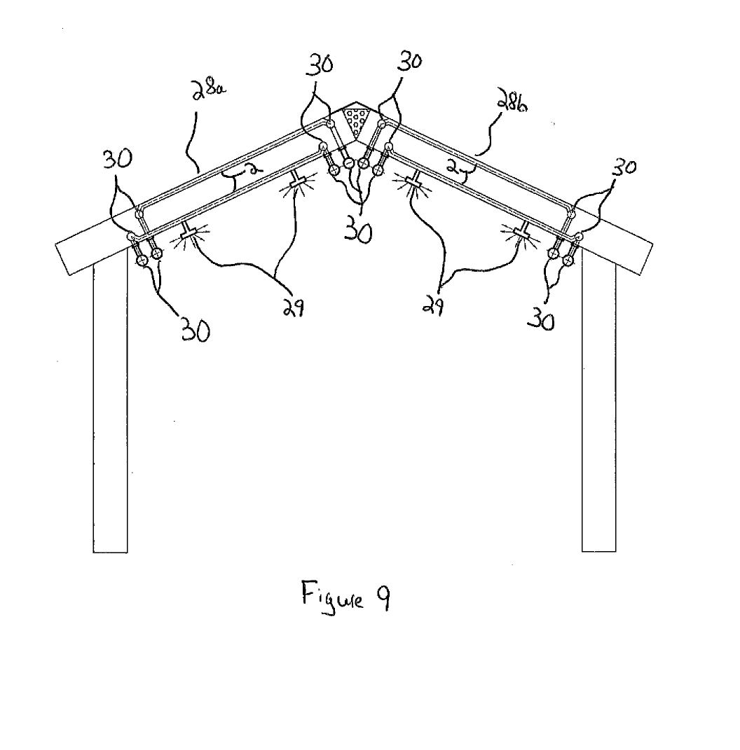

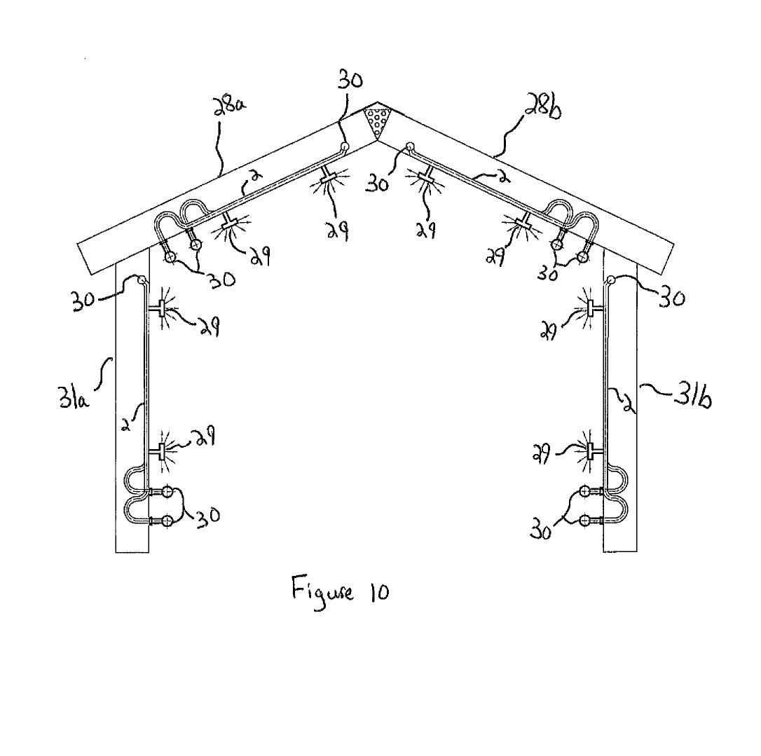

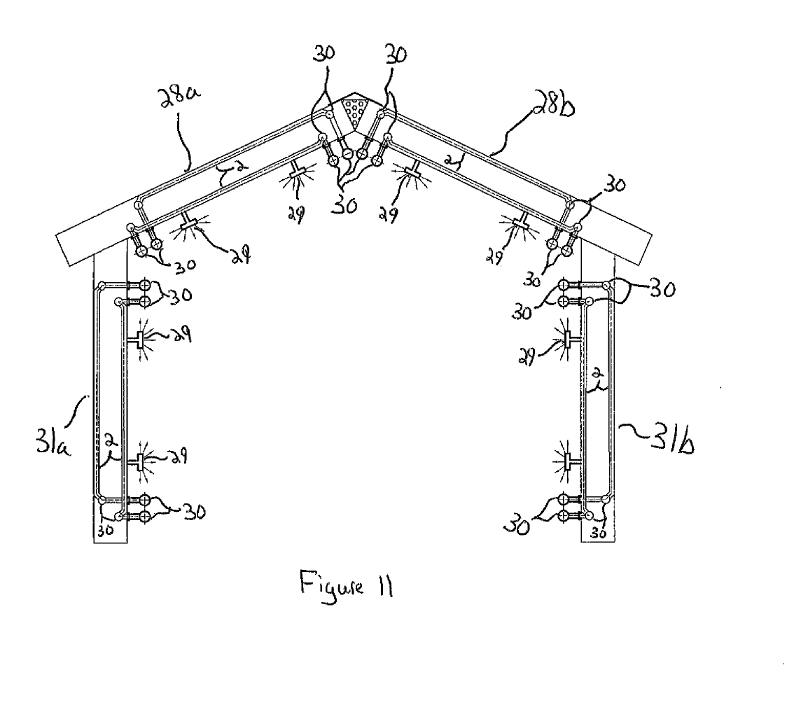

FIGS. 8-9 show embodiments of the self-extinguishing sandwich panels installed as roof structures. In these Figures are sliced views of two sandwich panels 28a and 28b that combine to form the roof of a structure and that have the flow pipes 2 therein. The have sprinkler devices 29 secured on the outside of the panel at points along the flow pipes. The sprinkler devices 29 in this embodiment are attached to the side of the sandwich panels that bounds an area so that the sprinkler devices are in communication with the bound area in the event of a fire. Also shown in this embodiment points 30 wherein some or all of the points may be valves, inlet and/or outlet points 30 where fluid may be regulated throughout the system, fluid may be supplied to the flow pipe system and/or fluid may be delivered from the flow pipe system. It is preferable to have the flow pipe inlet and/or outlet points located on the outside of the sandwich panel but they may be located on the inside. In FIGS. 10-11 are seen embodiments of the present invention where the self-extinguishing sandwich panels are used in the roof and wall panels 30a and 30b. In even further embodiments, one or more floor panels may also contain the self-extinguishing sandwich panels.

It is to be noted that any of the sprinkler devices described in this disclosure and/or known in the art may alternatively be used in any of the embodiments herein. Further, all or some of the points 30 that are shown in FIGS. 8-11 may, in other embodiments, be located at any other desired location in the system. In addition, some or all of the points 30 may alternatively represent joints that connect ends of the flow pipes and/or help the flow pipes transition. An example of a joint may be but is not limited to an elbow joint.

It is important to note that the sprinkler devices may be distributed at any desired location along the flow pipes and that, in cases where there is more than one panel, the panels may have a different amount of sprinkler devices. For example, one panel may have four sprinkler devices, while a second panel may have three sprinkler devices. In addition, the piping system in the present invention may consist of one main pipe that serves as the fluid supply pipe and fluid return pipe and that also travels through the panels. In this embodiment, the sprinkler devices may be located at any desired location along the main pipe. In other embodiments, there may be one main pipe that goes through some or all of the panels and where some of the panels have one main pipe, the main pip may connect to an inlet valve of a panel that has one or more flow pipes therein. The pipe(s) that go through the sandwich panels may be a straight line, may have alternating vertical sections, may have alternating horizontal sections, or may be a combination thereof.

The pipes traveling through the sandwich panels may travel on the first and/or second side surface of the sandwich panel core and reside just underneath the outer lining of the sandwich panel. Alternatively or additionally, the pipes travel may through at least a portion of the section of the core that is in between the first and second core side surface.

What is claimed is:

1. A fire-extinguishing system for use in the construction of an exterior/interior wall ceiling, roof, or floor of a structure, comprising:
at least one self-extinguishing panel, said panel comprising
a core having at least first side surface and a second side surface, a first end and a second end,
an outer lining that lines at least a portion of said first side surface and said second side surface,
a plurality of pipes disposed within said core, said plurality pipes adapted to receive a fluid flowing through said pipes, said plurality of pipes further having an inlet valve at an inlet to said plurality of pipes and an outlet valve at an outlet from said plurality of pipes, and
at least one sprinkler device secured on the exterior of the outer lining of at least one side surface of said core, said sprinkler device having at least one sensor for detecting a fire and at least one valve for controlling the flow of said fluid through said sprinkler device, said sprinkler device is activated when said valve is open and said sprinkler device is deactivated when said valve is closed, said sprinkler device in fluid communication with said pipes disposed within said panel and said side surface of said core that said sprinkler device extends is adjacent to an area for sprinkling fluid from said pipes;
at least one reservoir in fluid communication with at least one fluid supply pipe, said fluid supply pipe also in fluid communication with said inlet valve of said plurality of pipes to supply fluid to said inlet valve,
at least one fluid return pipe in fluid communication with said outlet valve of said plurality of pipes to supply fluid to said outlet valve and said fluid return pipe also in fluid communication with said fluid supply pipe to supply fluid from said panels back to said fluid return pipe;
a control unit regulating the flow of said fluid throughout the system;
a first means for circulating fluid in said system, wherein said first means is in communication with said control unit;
a second means for determining whether said sprinkler devices are activated, wherein said second means is in communication with said control unit;
a third means for determining the pressure of the fluid flow in said system, wherein said third means is in communication with said control unit; and
a fourth means for determining the volume of said fluid flowing through said system, wherein said fourth means is in communication with said control unit; when said sprinkler is deactivated said fluid in said system flows in a closed system from said reservoir to said fluid supply pipe, from said fluid supply pipe to said plurality of pipes via said inlet valve, from said plurality of pipes to said fluid return pipe via said outlet valve, and from said fluid return pipe to said fluid supply pipe; when said sprinkler becomes activated said second means detects said activation and transmits a signal to said control unit that said sprinkler is activated, said control unit closing said outlet valve of said plurality of pipes and said fluid flow in said system is from said reservoir to said fluid return pipe to said plurality of pipes via said inlet valve and out of said open valve on said sprinkler device to suppress the fire.

2. The system according to claim 1 wherein said fluid is water.

3. The system according to claim 2 wherein said first means for circulating said fluid is at least one pump.

4. The system according to claim 3 wherein said second means is at least one sensor for determining whether said sprinkler devices are activated.

5. The system according to claim 4 wherein said outlet valve of said plurality of pipes is closed when said sprinklers are activated.

6. The system according to claim 5 wherein said outlet valve of said plurality of pipes is open when said sprinklers are deactivated.

7. The system according to claim 6 wherein said third means is at least one sensor for determining the pressure of water flowing through said pipes.

8. The system according to claim 7 wherein said control unit directs said pump to stop circulating water when the water pressure is above an upper water pressure threshold and said sprinklers are deactivated.

9. The system according to claim 8 wherein said control unit directs said pump to stop circulating water when said water pressure is below a minimum water pressure threshold and said sprinkler devices are deactivated.

10. The system according to claim 7 wherein said fourth means is a sensor for determining the volume of fluid flowing through said system.

11. The system according to claim 10 wherein said control unit directs said pump to stop circulating water when the volume of water flowing through said system is below a water volume lower threshold and said sprinklers are deactivated.

12. The system according to claim 1 further comprising a user interface, wherein said user interface receives input from said control unit and displays an output for a user to interact.

13. The system according to claim 12 wherein said system further comprises a furnace for heating said fluid, said furnace being in fluid communication with said fluid return pipe, and said furnace transmitting and receiving signals from said user interface and said control unit.

14. The system according to claim 13 wherein said heat from said heated fluid flows through said plurality of pipes and transmits said heat from said fluid to an area that is enclosed by said self-extinguishing panel to heat said area.

15. The system according to claim 12 wherein said system further comprises a fluid cooling means in fluid communication with said fluid return pipe, and said fluid cooling means transmitting and receiving signals from said user interface and said control unit.

16. The system according to claim 15 wherein said cooled fluid flows through said plurality of pipes and transmits said cool temperature from said cooled fluid to an area that is enclosed by said self-extinguishing panel to cool said area.

17. The system according to claim 1 wherein said plurality of flow pipes is arranged horizontally in said panel.

18. The system according to claim 1 wherein said plurality of flow pipes is arranged vertically in said panel.

19. The system according to claim 1 wherein retaining members secure said plurality of pipes inside of said panel.

20. A panel for use in the construction of an exterior/interior wall ceiling, roof, or floor of a structure, comprising:
a core having at least a first side surface and a second side surface;
an outer lining that lines at least a portion of said first and said second side surface,
at least one pipe disposed within said core, wherein said pipe allows fluid to flow through said pipe and wherein said at least one pipe has an inlet for receiving a flow of fluid and an outlet for allowing a flow of fluid to leave said at least one pipe;
and least one sprinkler device connected to said at least one pipe, wherein said sprinkler device is in communication an area that is enclosed by said panel.
